(19) United States
(12) Patent Application Publication
(10) Pub. No.: US 2003/0039835 A1
(43) Pub. Date: Feb. 27, 2003

(54) Modified layered clay material and epoxy/clay nanocomposite containing the same

(75) Inventors: Tsung-Yen Tsai, Hsinchu Hsien (TW); Hung-Chou Kang, Hsinchu Hsien (TW); Meng-Song Yin, Hsinchu (TW); Kuo-Yuan Hsu, Miaoli Hsien (TW); Sung-Jeng Jong, Pingtung Hsien (TW)

Correspondence Address: SUGHRUE, MION, ZINN, MACPEAK & SEAS, PLLC, 2100 Pennsylvania Avenue, N.W., Washington, DC, 20037-3213, US

(73) Assignee: INDUSTRIAL TECHNOLOGY RESEARCH INSTITUTE

(21) Appl. No.: 09/983,194

(22) Filed: Oct. 23, 2001

(30) Foreign Application Priority Data
Aug. 17, 2001 (TW) 90120211

(51) Int. Cl. B32B 5/16

(52) U.S. Cl. 428/404; 523/200; 428/447; 428/446; 428/688

(57) ABSTRACT

A layered clay material is modified by ion exchange with (1) ZrOCl₂ and (2) a silane surfactant. The modified clay material is heat-kneaded with epoxy oligomers to undergo polymerization, thus obtaining an epoxy/clay composite comprising the clay material uniformly dispersed in the epoxy resin matrix on a nano-scale. The epoxy/clay nanocomposite has excellent adhesion and less hygroscopicity, which makes it especially suitable as molding or packaging material for electronic devices.

### BACKGROUND OF THE INVENTION

1. Field of the Invention

The present invention relates to a modified clay material and an epoxy/clay nanocomposite outstandingly suitable as molding or packaging material comprising the modified clay mineral.

2. Description of the Related Arts

Nanocomposites are a new class of materials, which contain polymer and minerals that exhibit ultra-fine phase dimensions, typically in the range of 1-100 nm. Experimental work on these minerals has generally shown that virtually all types and classes of nanocomposites lead to new and improved properties such as increased stiffness, strength, and heat resistance, and decreased moisture absorption, flammability, and permeability, when compared to their micro- and macrocomposite counterparts. Specifically, commercially available Nylon 6/clay nanocomposite shows that polymer matrix having layered clay minerals dispersed therein exhibits improved mechanical strength, heat distortion temperature (HDT), and impermeability to gas and water.

Epoxy resins have been widely used as encapsulating materials for electronic devices. However, the epoxy resins are not necessarily satisfactory in such applications when a higher degree of heat resistance, adhesion, dimensional stability, or less hygroscopicity is required. This has significantly restricted their use in molding or packaging applications. Therefore, an improvement upon epoxy encapsulating materials is called for.

To this end, the present invention discloses an epoxy/clay composite wherein a modified layered clay material is exfoliated and uniformly dispersed in an epoxy resin matrix to improve the characteristics required for high quality molding or packaging.

### SUMMARY OF THE INVENTION

A first object of the invention is to provide a modified layered clay material.

A second object of the invention is to provide an epoxy/clay nanocomposite comprising the modified layered clay material, which exhibits excellent adhesion and less hygroscopicity and is very suitable as a molding or packaging material.

To achieve the above objects, a layered clay material is modified by ion exchange with ZrOCl₂ and a silane surfactant. The modified clay material is heat-kneaded with epoxy oligomers to undergo polymerization. The silicate layers of the clay material are exfoliated during the polymerization and uniformly dispersed in the epoxy resin matrix on a nanometer length scale. Thus, an epoxy/clay nanocomposite is obtained with reduced hygroscopicity and enhanced adhesion.

### DETAILED DESCRIPTION OF THE INVENTION

The modified clay material of the invention is a layered clay material that is ion-exchanged with (1) ZrOCl₂ and (2) a silane surfactant. The layered clay material used in the present invention is preferably a layered silicate having a cation-exchange capacity ranging from about 50 to 200 meq/100 g. The layered silicate suitable for use herein includes, for example, smectite clay, vermiculite, halloysite, sericite, mica, and the like. Illustrative of suitable smectite clays are montmorillonite, saponite, beidellite, nontronite, hectorite, and stevensite.

The layered silicate is subjected to intercalation of two distinct modifiers by ion exchange to functionalize the clay material and to expand the interlayer spacing between the adjacent silicate layers so that the layered silicate is more readily exfoliated during the polymerization. This can be accomplished by immersing the layered silicate in an aqueous solution containing the modifier, followed by washing the treated layered silicate with water to remove excess ions, thereby effecting the ion-exchange operation. The first modifier used in the present invention is ZrOCl₂, which serves to increase the interlayer distance and afford hydroxyl (—OH) functionality to the clay material. The second modifier is a silane surfactant, which serves to further expand the interlayer distance to the desired extent by coupling with the clay material via a dehydroxy reaction. The silane surfactant suitable for use herein includes those containing at least one of the following functional groups: hydroxyl, carboxyl, epoxy, and ethylenically unsaturated bonds. A particularly preferred silane surfactant is (OCH₃)₃ ( (CH₂)₃OCH₂CHCH₂O) Si. The interlayer spacing of the modified clay material is preferably at least 20 Å before introduction of the epoxy resin.

The epoxy/clay nanocomposite of the present invention is prepared by dispersing the above-mentioned modified clay material in oligomers of an epoxy resin and polymerizing the oligomers into an epoxy polymer. The polymer/clay composite thus prepared includes an epoxy polymer matrix and a layered clay material uniformly dispersed therein on a nano-scale. In accordance with the present invention, the modified clay material is preferably present in an amount ranging from about 0.5% to 10% by weight, and more preferably from about 1.0% to 6.0% by weight, based on the total weight of the epoxy/clay composite. It is preferable that the clay material contained in the polymer matrix has a interlayer spacing of at least 34 Å.

The epoxy resin suitable for use in the present invention includes but is not limited to bisphenol A type epoxy resins, brominated epoxy resins (bromine content: 10-60 wt %), novolac epoxy resins, multifunctional epoxy resins, and aliphatic epoxy resins. A mixture of the above is also suitable for use. Exemplary epoxy resins include bisphenol A epoxy resin, tetrabromo bisphenol A epoxy resin, tetrabromo bisphenol A polyphenol epoxy resin, ortho-cresol novolac epoxy resin, N,N,N′,N′-tetra(2,3-epoxypropyl)-P′,P′-methylaniline, N,N-bis(2,3-epoxypropyl)-4-amino-phenylepoxypropyl ether, 4-epoxypropylene-N,N-bisepxoypropylaniline and the like.

The epoxy/clay nanocomposite of the present invention may further comprise an ordinary epoxy curing agent such as dicyandiamide, phenol novolak, or trimellitic anhydride (TMA). The amount of the curing agent to be used is 0.7 to 1.2 equivalents based on the epoxy group. An amount of the curing agent of lower than 0.7 equivalents or over 1.2 equivalents based on the epoxy group may result in insufficient curing. In addition, the epoxy/clay nanocomposite may further comprise a curing accelerator commonly used for accelerating the curing of an epoxy resin. The curing accelerator includes, for example, imidazole compounds such as 2-ehtyl-4-methylimidazole and 1-benzyl-2-methylimidazole; and tertiary amines such as N′,N-dimethylbenzylamine (BDMA). These compounds can be used singly or in a form of mixture. The curing accelerator should be used in a small amount as far as the accelerator is sufficient for accelerating the curing of the epoxy resin. The amount of the curing accelerator to be used is preferably between 0.1 and 1 parts by weight based on 100 parts by weight of the epoxy resin.

Furthermore, the nanocomposite may incorporate known additives such as inorganic fillers, flame retardants, mold releasing agents, surface treating agents and the like depending upon the end use. The inorganic fillers include silica, alumina, aluminum hydroxide, talc, and glass fibers. These may be used in a mixture of different shapes and different sizes to increase the filler volume. The flame retardants include brominated epoxy resins, antimony trioxdie (Sb₂O₃), and the like. The mold releasing agents include waxes, metal salts of higher fatty acids such as zinc stearate, and the surface treating agents include silane coupling agents and the like.

The epoxy/clay nanocomposites of the present invention have greatly improved adhesion and a lower hygroscopic property so that they are highly suitable for practical use as encapsulating materials for electronic devices. According to a preferred embodiment of the invention, an epoxy/clay nanocomposite having an adhesion of above 83 kgf/cm² and a water uptake of less than 0.2 wt % can be obtained.

With the epoxy/clay nanocomposites of the present invention, electronic parts of semiconductors and the like can be encapsulated by molding and curing according to any one of known prior techniques such as transfer molding, compression molding, injection molding and the like. In addition, the epoxy/clay nanocomposites of the present invention can also be used as adhesives, surface coatings, and reinforced materials.

Without intending to limit it in any manner, the present invention will be further illustrated by the following examples.

### PREPARATIVE EXAMPLE

60 g of montmorillonite powder was dispersed in 3500 ml of deionized water, followed by stirring for 4 hours to give a liquid suspension. A solution of 60 g of ZrOCl₂ in 500 ml water was prepared and the pH value of the solution was adjusted to about 0.83 by addition of NH₄OH. To the liquid suspension, the ZrOCl₂ solution was slowly added with vigorous stirring. After the addition was completed, the mixture was stirred for one hour at 80° C., and then aged at same temperature for 20 days. After this, the mixture was filtered and washed with deionized water twice. The filtering and washing procedures were repeated three times.

The dry compact thus obtained was dispersed in 3500 ml of deionized water, to which was added 48.6 g of (OCH₃)₃((CH₂)₃OCH₂CHCH₂O)Si as a silane modifier, followed by stirring at 80° C. for 6 hours. The resulting mixture was filtered, dried at 100° C., and ground into powders, giving the desired modified clay material.

X-ray diffraction (XRD) analysis indicates that the interlayer spacing of montmorillonite was 18.6 Å after modification by ZrOCl₂, and was increased to 22.1 Å after modification by the silane modifier.

### COMPARATIVE EXAMPLE

Fused silica fillers of different particle sizes (available from Denki Kagaku Kogyo Co.), including 3.9 g of “FS-30” (6.2 μm), 69.2 g of “FS-90C” (17.3 μm), 166.2 g of “FB-48” (16.5 μm), 340.2 g of “FB-74” (19.8 μm), and 64.3 g of “FG-301” (6.8 μm) were uniformly mixed and brought into contact with 3.2 g of a silane surfactant, (OCH₃)₃ ( (CH₂)₃OCH₂CHCH₂O) Si. In a kneader, the treated filler mixture (constituting 82.3% by weight of the total blend) was blended with 12.0 g of spherical silica powder (average diameter: 2 μm), 2.4 g of Sb₂O₃ as flame retardant, 2.4 g of brominated epoxy resin “Epiclon 152” (from Epiclon Co.), 0.8 g of “WAX OP” and 2.4 g of “WAX E” as mold releasing agents, 61.7 g of epoxy resin “HP-7200” (from Epiclon Co.) and 30.9 g of epoxy resin “ESCN-195XL” (from Sumitomo Chemical Co.), 34.0 of phenolic resin “HRJ-1583” (from Schenectady International, Inc.; P/E ratio=0.85), 4.8 g of UCAT-841 (from Sanfubro Co.) as catalyst, and 1.6 g of carbon black, heat-kneaded with a 90° C. hot roller and a 15° C. cold roller for ten minutes and then pulverized by a pulverizer. The resulting powders were press molded into test specimens to evaluate gel time, spiral flow, glass transition temperature (Tg), water uptake (a measure of hygroscopicity), and adhesion. The results are listed below:

| | |
|---|---|
| Gel time (sec) = 31.8, | Spiral flow (in) = 39.8, |
| Tg (° C.) = 167.7, | Water uptake (wt %) = 0.20, |
| Adhesion (kgf/cm²) = 65.8. | |

### EXAMPLE 1

3.9 g (3% by weight of the total resin) of the modified clay material obtained in the Preparative Example, and fused silica fillers of different particle sizes, including 40.0 g of “FS-30” (6.2 μm), 29.2 g of “FS-90C” (17.3 μm), 166.2 g of “FB-48” (16.5 μm), 340.2 g of “FB-74” (19.8 μm), and 64.3 g of “FG-301” (6.8 μm; all available from Denki Kagaku Kogyo Co.) were uniformly mixed and brought into contact with 3.2 g of a silane surfactant, (OCH₃)₃((CH₂)₃OCH₂CHCH₂O)Si. In a kneader, the filler mixture (constituting 82.3% by weight of the blend) and the modified clay material were blended with 12.0 g of spherical silica powder (average diameter: 2 μm), 2.4 g of Sb₂O₃ as flame retardant, 2.4 g of brominated epoxy resin “Epiclon 152” (from Epiclon Co.), 0.8 g of “WAX OP” and 2.4 g of “WAX E” as mold releasing agents, 61.7 g of epoxy resin “HP-7200” (from Epiclon Co.) and 30.9 g of epoxy resin “ESCN-195XL” (from Sumitomo Chemical Co.), 34.0 of phenolic resin “HRJ-1583” (from Schenectady International, Inc.; P/E ratio=0.85), 4.8 g of UCAT-841 (from Sanfubro Co.) as catalyst, and 1.6 g of carbon black, heat-kneaded with a 90° C. hot roller and a 15° C. cold roller for ten minutes and then pulverized by a pulverizer. The resulting powders were press molded into test specimens to evaluate gel time, spiral flow, glass transition temperature (Tg), water uptake (a measure of hygroscopicity), and adhesion. The results are listed below:

| | |
|---|---|
| Gel time (sec) = 31.6, | Spiral flow (in) = 37.6, |
| Tg (° C.) = 167.9, | Water uptake (wt %) = 0.23, |
| Adhesion (kgf/cm²) = 83.9. | |

Compared to the Comparative Example, the adhesion was increased by 28% upon addition of the modified clay material of the invention.

### EXAMPLE 2

3.9 g (3% by weight of the total resin) of the modified clay material obtained in the Preparative Example, and fused silica fillers of different particle sizes, including 34.34 g of “FS-30” (6.2 μm), 69.2 g of “FS-90C” (17.3 μm), 286.24 g of “FB-48” (16.5 μm), 186.24 g of “FB-74” (19.8 μm), and 74.78 g of “FG-301” (6.8 μm; all available from Denki Kagaku Kogyo Co.) were uniformly mixed and brought into contact with 3.2 g of a silane surfactant, (OCH₃)₃((CH₂)₃OCH₂CHCH₂O)Si. In a kneader, the filler mixture (constituting 83.99% by weight of the blend) and the modified clay material were blended with 12.0 g of spherical silica powder (average diameter: 2 μm), 2.4 g of Sb₂O₃ as flame retardant, 2.4 g of brominated epoxy resin “Epiclon 152” (from Epiclon Co.), 0.8 g of “WAX OP” and 2.4 g of “WAX E” as mold releasing agents, 56.59 g of epoxy resin “HP-7200” (from Epiclon Co.) and 28.3 g of epoxy resin “ESCN-195XL” (from Sumitomo Chemical Co.), 31.21 of phenolic resin “HRJ-1583” (from Schenectady International, Inc.; P/E ratio=0.85), 4.8 g of UCAT-841 (from Sanfubro Co.) as catalyst, and 1.6 g of carbon black, heat-kneaded with a 90° C. hot roller and a 15° C. cold roller for ten minutes and then pulverized by a pulverizer. The resulting powders were press molded into test specimens to evaluate gel time, spiral flow, glass transition temperature (Tg), water uptake (a measure of hygroscopicity), and adhesion. The results are listed below:

| | |
|---|---|
| Gel time (sec) = 31.6, | Spiral flow (in) = 22.8, |
| Tg (° C.) = 170.6, | Water uptake (wt %) = 0.178, |
| Adhesion (kgf/cm²) = 83.9. | |

Compared to the Comparative Example, the water uptake was decreased by 12.36% upon addition of the modified clay material of the invention.

While the invention has been particularly shown and described with reference to the preferred embodiment thereof, it will be understood by those skilled in the art that various changes in form and details may be made without departing from the spirit and scope of the invention.

What is claimed is:

1. A modified layered clay material, comprising:
a layered clay material being modified by ion exchange with (1) ZrOCl₂ and (2) a silane surfactant.

2. The modified layered clay material as claimed in claim 1, wherein the layered clay mineral has a cation-exchange capacity ranging from about 50 to 200 meq/100 g.

3. The modified layered clay material as claimed in claim 1, wherein the layered clay mineral is selected from the group consisting of smectite clay, vermiculite, halloysite, sericite, and mica.

4. The modified layered clay material as claimed in claim 1, which has interlayer spacing at least about 20 Å.

5. The modified layered clay material as claimed in claim 1, wherein the silane surfactant contains at least one functional group selected from the group consisting of hydroxyl, carboxyl, epoxy, and ethylenically unsaturated bonds.

6. An epoxy/clay nanocomposite, comprising:
a polymer matrix comprising an epoxy resin; and
a layered clay material uniformly dispersed in the polymer matrix, the layered clay material being modified by ion exchange with (1) ZrOCl₂ and (2) a silane surfactant.

7. The epoxy/clay nanocomposite as claimed in claim 6, wherein the layered clay material is present in an amount ranging from about 0.5% and 10% by weight based on the total weight of the nanocomposite.

8. The epoxy/clay nanocomposite as claimed in claim 6, wherein the layered clay mineral has a cation-exchange capacity ranging from about 50 to 200 meq/100 g.

9. The epoxy/clay nanocomposite as claimed in claim 6, wherein the layered clay mineral is selected from the group consisting of smectite clay, vermiculite, halloysite, sericite, and mica.

10. The epoxy/clay nanocomposite as claimed in claim 6, which has interlayer spacing at least about 34 Å.

11. The epoxy/clay nanocomposite as claimed in claim 6, wherein the silane surfactant contains at least one functional group selected from the group consisting of hydroxyl, carboxyl, epoxy, and ethylenically unsaturated bonds.

12. The epoxy/clay nanocomposite as claimed in claim 6, further comprising a curing agent.

13. The epoxy/clay nanocomposite as claimed in claim 6, further comprising an inorganic filler.

14. The epoxy/clay nanocomposite as claimed in claim 6, further comprising at least one additive selected from the group consisting of curing accelerators, molding releasing agents, flame retardants, and surface treating agents.

15. The epoxy/clay nanocomposite as claimed in claim 6, which exhibits an adhesion of above 83 kgf/cm².

16. The epoxy/clay nanocomposite as claimed in claim 6, which is used as a molding or packaging material.

17. The epoxy/clay nanocomposite as claimed in claim 6, which is used as an adhesion material.
